(19) United States
(12) Patent Application Publication
(10) Pub. No.: US 2008/0231056 A1
(43) Pub. Date: Sep. 25, 2008

(54) Hydroelectric generator turbine flow guide structure

(76) Inventor: Chang Ting Wen, Miaoli (TW)

Correspondence Address: BIRCH STEWART KOLASCH & BIRCH, PO BOX 747, FALLS CHURCH, VA, 22040-0747, US

(21) Appl. No.: 11/725,500

(22) Filed: Mar. 20, 2007

(51) Int. Cl. F03B 13/00

(52) U.S. Cl. 290/54

(57) ABSTRACT

The present invention discloses a hydroelectric generator turbine flow guide structure. The turbine is arranged in a base, and the base includes an inlet port and an outlet port for allowing water to flow into and out of the base, and a flow guide passage for allowing the water to flow; power of the turbine is transmitted to a generator via a power transmission member, the base includes a flow guide base and the turbine arranged on the flow guide base; wherein the flow guide base includes at least one jet nozzle for introducing the water flow to the turbine, and the at least one jet nozzle has a diameter gradually decreasing along a direction from the base toward the turbine. The hydroelectric generator turbine flow guide structure of the present invention takes the most advantage of the water pressure and reduces pressure loss of the flow.

### BACKGROUND OF THE INVENTION

1. Field of the Invention

The present invention relates to a hydroelectric generator structure, and more particularly, to a hydroelectric generator turbine flow guide structure.

2. Description of Related Art

Currently, regarding ways of power generation, the hydroelectric generation is most environment-friendly and causes no pollution. However, if water pressure is insufficient, or the fall of the water does not create enough power, the hydroelectric generation cannot provide a sufficient amount of electricity.

Referring to FIGS. 1 and 2, which illustrate a structure of a conventional small-scale hydroelectric generator, a turbine 90 is located in a base 80. An axle of the turbine 90 is connected with a generator (not labelled) via a power transmission member 91, so that the turbine 90, after being rotated, transmits power to the generator for generating electricity. The base 80 forms thereon an outlet port 81 and an inlet port 82 for allowing water to flow out and into the base 80.

When flowing into the base 80 via the inlet port 82, the water drives blades 93 of the turbine 90 to rotate, thereby transmitting the power to the generator, and then the water flows out from the outlet port 81. The outlet port 81 and inlet port 82 are located in a same plane, and when water flows from the inlet port 82 to the outlet port 81, the path water needs to travel is longer, and thus a larger water pressure is required to enable water flow. Therefore, a larger water pressure will be consumed; if the water pressure is not enough, the blades 93 of the turbine 90 cannot be rotated successfully, which results in the failure of power generation at the generator due to insufficient power transmission.

### SUMMARY OF THE INVENTION

A technical problem the present invention aims to solve is to provide a hydroelectric generator turbine flow guide structure that can take the most advantage of water pressure and reduce pressure loss of water flow.

To solve the technical problem set forth above, the technical solution of the present invention is to propose a hydroelectric generator turbine flow guide structure; the turbine is arranged in a base, the base includes an inlet port and an outlet port for allowing water to flow into and out of the base, and a flow guide passage for allowing the water to flow; power of the turbine is transmitted to a generator via a power transmission member, the base includes a flow guide base and the turbine arranged on the flow guide base; wherein the flow guide base includes at least one jet nozzle for introducing the water flow to the turbine, and the at least one jet nozzle has a diameter gradually decreasing along a direction from the base toward the turbine.

The inlet port and outlet port of the base of the hydroelectric generator turbine flow guide structure are located in different planes.

An inclination angle of the jet nozzle of the hydroelectric generator turbine flow guide structure conforms to a flow direction of the flow.

The base of the hydroelectric generator turbine flow guide structure is of a round box-like shape that fits with a profile of the turbine, and forms a top cover at a top thereof for allowing removal, replacement or repair of internal components.

The turbine of the hydroelectric generator turbine flow guide structure forms a flow guide portion for guiding the flow to the outlet port.

The flow guide portion of the hydroelectric generator turbine flow guide structure near the inlet port is inclined at an angle of R toward the outlet port.

The turbine of the hydroelectric generator turbine flow guide structure comprises a plurality of blades, and the plurality of blades include main blades and auxiliary blades.

The plurality of blades of the hydroelectric generator turbine flow guide structure is arc-shaped.

The power transmission member of the hydroelectric generator turbine flow guide structure is an axle.

A water flow control valve is arranged between the jet nozzle and the turbine of the hydroelectric generator turbine flow guide structure for adjusting water pressure to a preset water pressure.

In comparison with prior arts, the flow guide base of the base of the hydroelectric generator turbine flow guide structure includes at least one jet nozzle for introducing the water flow to the turbine, and the at least one jet nozzle has a diameter gradually decreasing along a direction from the base toward the turbine, which can take the most advantage of the water pressure and reduce the pressure loss of the flow.

### BRIEF DESCRIPTION OF THE DRAWINGS

A further detailed description of the present invention will be made in conjunction with drawings and embodiments.

FIG. 1 is a schematic view of a structure of a conventional hydroelectric generator turbine;

FIG. 2 is a schematic view of a structure of another conventional hydroelectric generator turbine;

FIG. 3 is a perspective view of a hydroelectric generator turbine flow guide structure in accordance with the present invention;

FIG. 4 is a schematic view showing a flow guided by the hydroelectric generator turbine flow guide structure in accordance with the present invention;

FIG. 5 is a cross sectional view of a generator and a turbine of the hydroelectric generator turbine flow guide structure in accordance with the present invention;

FIG. 6 is a view showing the hydroelectric generator turbine flow guide structure of the present invention being mounted to a water tap;

FIG. 7 is another view showing the hydroelectric generator turbine flow guide structure of the present invention being mounted to a water tap;

FIG. 8 is a further view showing the hydroelectric generator turbine flow guide structure of the present invention being mounted to a water tap; and

FIG. 9 is a view showing the hydroelectric generator turbine flow guide structure of the present invention being mounted to a water heater.

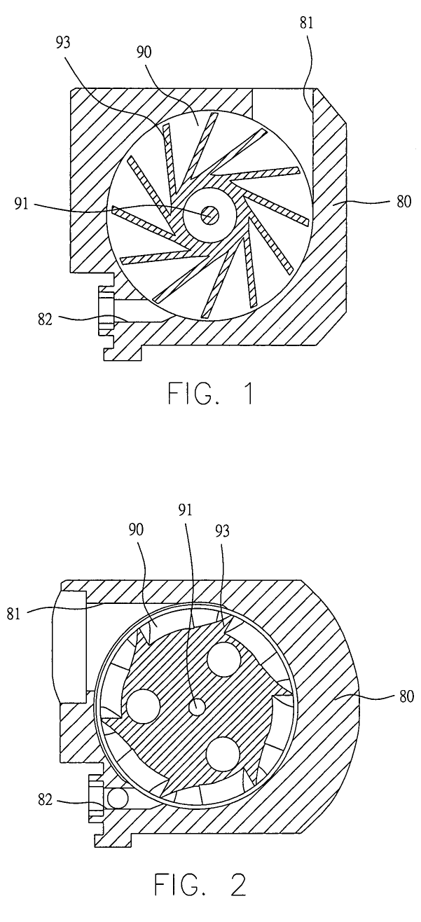

### DETAILED DESCRIPTION OF THE PREFERRED EMBODIMENTS

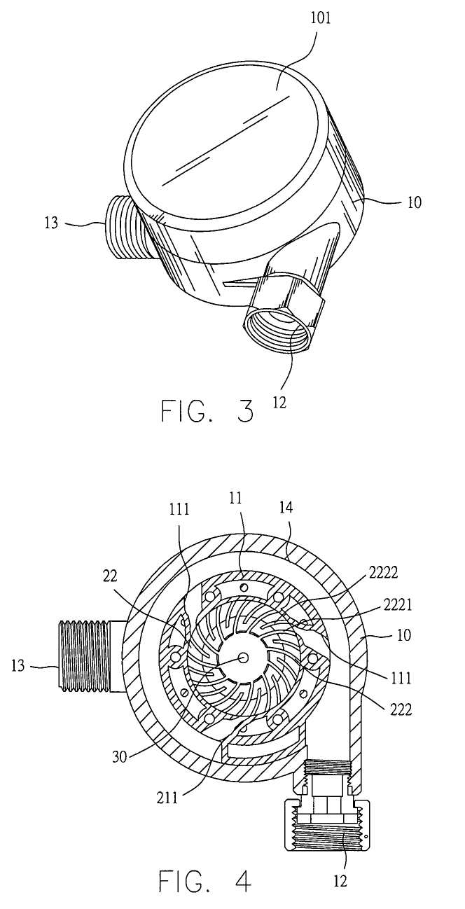

Referring to FIGS. 3 through 5, a hydroelectric generator turbine flow guide structure in accordance with the present invention includes a turbine 22 arranged in a base 10. Power of the turbine 22 is transmitted to a generator 40 via a power transmission member 30 (in this embodiment, the power transmission member 30 is an axle). After the turbine 22 and the power transmission member 30 are rotated, the power is transmitted to the generator 40 for generating electricity.

Referring again to FIG. 3, the base 10 is of a round box-like shape that fits with a profile of the turbine 22, and forms a top cover 101 at a top thereof for allowing removal, replacement or repair of internal components, and the base 10 forms an inlet port 12 and an outlet port 13 for allowing water to flow into and out of the base 10, and a flow guide passage 14 for allowing the water to flow. The inlet port 12 and the outlet port 13 are located in different planes. In this embodiment, the inlet port 12 is located at a lateral side of the base 10, while the outlet port 13 is located at an underside of the base 10, which makes the inlet port 12 perpendicular to the outlet port 13.

The base 10 includes a flow guide base 11 and the turbine 22 positioned on the flow guide base 11. The flow guide base 11 has at least one jet nozzle 111 (In this embodiment, there are three jet nozzles 111) for introducing the water flow to the turbine 22. The jet nozzle 111 has a diameter gradually decreasing along a direction from the base 10 toward the turbine 22, and an inclination angle thereof conforms to a flow direction of the flow to increase the pressure of the flow, and jets a highly pressurized water flow towards the turbine 22, here the water pressure is fully utilized in order to rotate the turbine 22. A water flow control valve (not shown) may be disposed between the jet nozzle 111 and the turbine 22. When the water flows to the jet nozzle 111, because the diameter of the jet nozzle 111 gradually decreases along the direction from the base 10 toward the turbine 22, the water flow speed gradually increases. If the water pressure is lower than a preset water pressure at this stage, the water flow control valve is located at an appropriate position, and the size of the jet nozzle 111 remains the same, after the water is pressurized, a flow path is suddenly widened, thus the water is jetted out due to pressure release. If the water pressure is higher than the preset water pressure, because the water flow control valve is pushed to an appropriate position, the jet nozzle 111 is made larger in size (At this time, the overlarge pressure is released, making the pressure of the water flowing to the turbine 22 decrease to the preset pressure).

The turbine 22 forms a flow guide portion 221 for guiding the flow to the outlet port 13, and a plurality of blades 222. The blades 222 include main blades 2221 and auxiliary blades 2222, and are arc-shaped. The aforesaid flow guide portion 221 is near the inlet port 12 and inclined at an angle of R toward the outlet port 13, which not only reduces the pressure loss of water flow, but also guides the flow from the inlet port 12 to the outlet port 13.

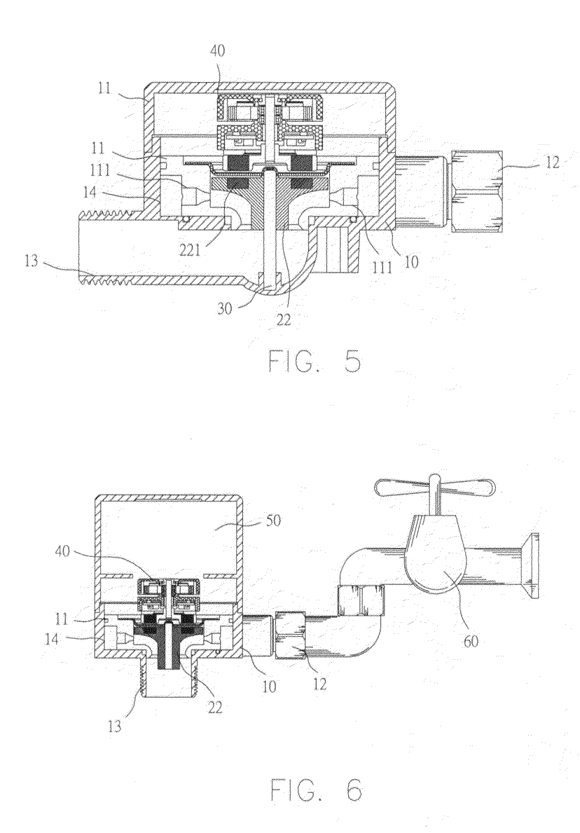

Referring to FIG. 6, the base 10 is assembled to a water tap 60 at an appropriate position thereof, and an ozone generator 50 is connected to a top of the base 10. The water flows into the base 10 via the inlet port 12, and through the jet nozzle 111 to rotate the turbine 22. The water is then guided to the outlet port 13 by the flow guide portion 221 of the turbine 22, for increasing the water pressure to drive the main blades 2221 and auxiliary blades 2222 to rotate, thereby transmitting the power to the generator 40. The generator 40 can also supply its power to the ozone generator 50, allowing the water discharged via the outlet port 13 to contain ozone to achieve disinfection, deodorization, and bleaching. The outlet port 13 can be arranged to discharge water from the lateral side or underside of the base 10 according to different needs. The outlet port 13 as shown in FIG. 5 discharges water from the lateral side, and the outlet port 13 as shown in FIG. 6 discharges water from the underside.

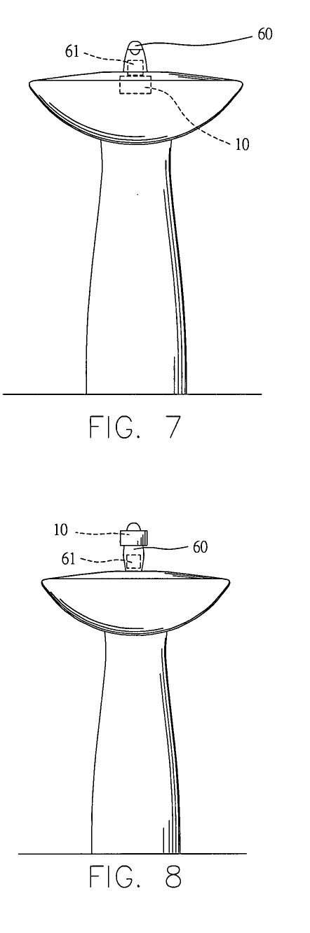

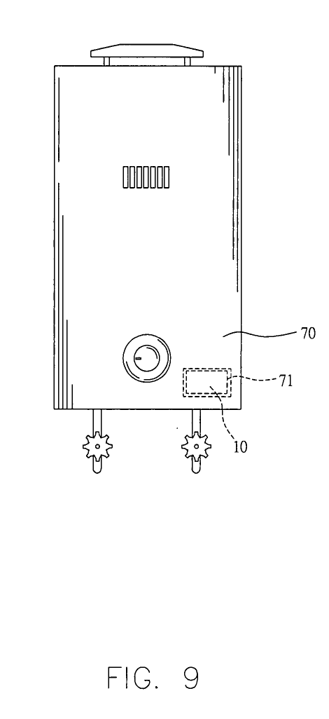

Referring to FIG. 7 and FIG. 8, the base 10 is mounted on a hand-wash basin to supply power to a sensing device 61 of the water tap 60. The base 10 can be concealably mounted in a pipe within the hand-wash basin, or be mounted to an outlet of the water tap 60 under direct exposure, or be a substitute for a battery holder 71 of a water heater 70 (see FIG. 9), or be disposed at a water inlet of a washing machine and used as a hydroelectric generator for ozone generation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hydroelectric generator turbine flow guide structure comprising a turbine arranged in a base, the base comprising an inlet port and an outlet port for allowing water to flow into and out of the base, and a flow guide passage for allowing the water to flow; power of the turbine being transmitted to a generator via a power transmission member, the base comprising a flow guide base and the turbine arranged on the flow guide base; wherein the flow guide base comprises at least one jet nozzle for introducing the water flow to the turbine, and the at least one jet nozzle has a diameter gradually decreasing along a direction from the base toward the turbine.

2. The hydroelectric generator turbine flow guide structure in accordance with claim 1, wherein the inlet port and outlet port of the base are located in different planes.

3. The hydroelectric generator turbine flow guide structure in accordance with claim 1, wherein an inclination angle of the jet nozzle conforms to a flow direction of the flow.

4. The hydroelectric generator turbine flow guide structure in accordance with claim 1, wherein the base is of a round box-like shape that fits with a profile of the turbine, and forms a top cover at a top thereof for allowing removal, replacement or repair of internal components.

5. The hydroelectric generator turbine flow guide structure in accordance with claim 1, wherein the turbine forms a flow guide portion for guiding the flow to the outlet port.

6. The hydroelectric generator turbine flow guide structure in accordance with claim 5, wherein the flow guide portion near the inlet port is inclined at an angle of R toward the outlet port.

7. The hydroelectric generator turbine flow guide structure in accordance with claim 1, wherein the turbine comprises a plurality of blades, and the plurality of blades include main blades and auxiliary blades.

8. The hydroelectric generator turbine flow guide structure in accordance with claim 7, wherein the plurality of blades is arc-shaped.

9. The hydroelectric generator turbine flow guide structure in accordance with claim 1, wherein the power transmission member is an axle.

10. The hydroelectric generator turbine flow guide structure in accordance with claim 1, wherein a water flow control valve is arranged between the jet nozzle and the turbine for adjusting water pressure to a preset water pressure.
